(19) United States
(12) Patent Application Publication
(10) Pub. No.: US 2011/0131348 A1
(43) Pub. Date: Jun. 2, 2011

(54) CONTROL SYSTEM AND CPU UNIT

(75) Inventors: Akihiro Onozuka, Hitachi (JP); Katsuhito Shimizu, Hitachi (JP); Yusaku Otsuka, Hitachiota (JP); Yukiko Tahara, Hitachinaka (JP); Masakazu Ishikawa, Hitachi (JP); Eiji Kobayashi, Hitachinaka (JP); Wataru Sasaki, Hitachiota (JP); Akihiro Nakano, Iwaki (JP); Yuusuke Seki, Hitachi (JP)

(73) Assignee: HITACHI, LTD.

(21) Appl. No.: 12/952,470

(22) Filed: Nov. 23, 2010

(30) Foreign Application Priority Data
Nov. 27, 2009 (JP) 2009-270775

(51) Int. Cl. G06F 3/00

(52) U.S. Cl. 710/30

(57) ABSTRACT

In the disclosed control system, loops of 1st path and 2nd path are formed connecting an active CPU unit and each of RIO units, the direction of data frame transfer through the loop of 1st path being opposite to that of the data frame transfer through the loop 2nd path. Reflective electro-optical transducer modules are used in the RIO units which are connected with the active CPU unit so that a standby CPU unit can also be connected. Further, the loop of 1st path and the loop of 2nd path are formed connecting the standby CPU module and each of the RIO modules. The data frame transfer directions through the loops connecting the active CPU unit and each of the RIO units are opposite to the data frame transfer directions through the corresponding loops connecting the standby CPU unit and each of the RIO units.

### BACKGROUND OF THE INVENTION

This invention relates to a control system and a CPU unit for use in the control system.

In a control system used in a facility such as a steel plant or a nuclear power plant, in which the first priority is to maintain security, extremely high availability is required, the term “availability” used here being defined as an index of how resistive the control system is to a failure, or simply as operation availability. This is because a fatal accident might be incurred if the control system stops operating for some cause.

JP-A-2010-200016 discloses an example of the related conventional art.

### SUMMARY OF THE INVENTION

According to the conventional control system in general, a single CPU unit which commands a sequence control or a feedback control is connected with a single Remote Input/Output Unit (hereafter referred to as “RIO unit”) which executes a sequence control or a feedback control on the controlled system. Indeed, a single CPU is a load consuming low power, but if a plurality of RIO units are used, so many CPU units must accompany them. Thus, the CPUs result in the increase in the production cost of the entire system. In order to solve this problem, the inventor of this invention has produced an improved CPU which can control plural RIO units. Accordingly, a data frame is provided with an originating address and a destination address so that a desired party to be communicated which can be specified from among plural communicating parties.

However, it was ascertained that when a number of controlled systems appear on the network, the mere duplication of lines cannot sustain the availability of the control system in use.

For example, in a network where a number of RIO modules are connected linearly with a CPU unit, a break in an intermediate portion of the network line may cause the possibility of the RIO module at the extreme end failing in communication, to rise to the maximum level.

The object of this invention, which has been made to solve the above mentioned problem, is to provide a communication apparatus and a control system used in it, which can enjoy an improved availability and also can locate the positions of abnormalities throughout the network lines.

In order to solve the above mentioned problems, a control system according to this invention comprises:

a first CPU module for simultaneously transmitting request data frames onto lines of 1st and 2nd paths and for receiving reply data frames from the lines of 1st and 2nd paths;

a first transducer module connected with the line of 1st path of the first CPU module, for outputting the request data frame at its transmission terminal and for receiving the reply data frame at its reception terminal;

a second transducer module connected with the line of 2nd path of the first CPU module, for outputting the request data frame at its transmission terminal and for receiving the reply data frame at its reception terminal;

a first remote input/output module connected with an actuator and a sensor installed on a controlled system, for receiving the request data frames from the lines of 1st and 2nd paths and for simultaneously transmitting the reply data frames onto the lines of 1st and 2nd paths;

a third transducer module connected with the line of 1st path of the first remote input/output module, for receiving the request data frame from the transmission terminal of the first transducer module;

a fourth transducer module connected with the line of 1st path of the first remote input/output module, for outputting the reply data frame at its transmission terminal;

a fifth transducer module connected with the line of 2nd path of the first remote input/output module, for outputting the reply data frame to the reception terminal of the second transducer module;

a sixth transducer module connected with the line of 2nd path of the first remote input/output module, for receiving the request data frame;

a second remote input/output module having the same configuration as the first remote input/output module, for receiving the request data frames from the lines of 1st and 2nd paths and for simultaneously transmitting the reply data frames onto the lines of 1st and 2nd paths;

a seventh transducer module connected with the line of 1st path of the second remote input/output module, for receiving the request data frame from the transmission terminal of the fourth transducer module;

an eighth transducer module connected with the line of 1st path of the second remote input/output module, for outputting reply data frame at its transmission terminal;

a ninth transducer module connected with the line of 2nd path of the second remote input/output module, for outputting the reply data frame to the reception terminal of the sixth transducer module; and

a tenth transducer module connected with the line of 2nd path of the second remote input/output module, for receiving the request data frame from the reception terminal of the second transducer module.

In the control system, the loop of the line of 1st path and the loop of the line of 2nd path are formed connecting an active CPU unit and each of remote input/output units, the direction of data frame transfer through the loop of the line of 1st path being opposite to that of the data frame transfer through the loop of the line of 2nd path. By constructing the network of the control system in such a manner as described above, the network can exhibit a high resistivity to line failures that may concentrate on a single spot and therefore provide a high availability.

In order to solve the above mentioned problem, a CPU unit according to this invention comprises:

a CPU module for simultaneously transmitting request data frames onto lines of 1st and 2nd paths and for receiving reply data frames from the lines of 1st and 2nd paths;

a first transducer module connected with the line of 1st path of the CPU module, for outputting the request data frame at its transmission terminal and for receiving the reply data frame at its reception terminal;

a second transducer module connected with the line of 2nd path of the CPU module, for outputting the request data frame at its transmission terminal and for receiving the reply data frame at its reception terminal;

a first frame discriminator for discriminating the sorts of the request and reply data frames arriving at the first transducer module;

a first request frame transmission flag register in which the fact that a request data frame has been transmitted from the CPU module, is recorded by the first frame discriminator when the first frame discriminator detects the transmission of the request data frame from the CPU module;

a first request frame circulation flag register in which the fact that a reply data frame has arrived from outside, is recorded by the first frame discriminator when the first frame discriminator detects the arrival of the reply data frame from outside while the first request frame transmission flag register retains the record that the CPU module has transmitted a request data frame;

a first reply frame reception flag register in which the fact that a reply data frame has arrived from outside, is recorded by the first frame discriminator when the first frame discriminator detects the arrival of the reply data frame from outside while the first request frame circulation flag register retains the record that the request data frame has arrived from outside;

a second frame discriminator for discriminating the sorts of the request and reply data frames arriving at the second transducer module;

a second request frame transmission flag register in which the fact that a request data frame has been transmitted from the CPU module, is recorded by the second frame discriminator when the second frame discriminator detects the transmission of the request data frame from the CPU module;

a second request frame circulation flag register in which the fact that a reply data frame has arrived from outside, is recorded by the second frame discriminator when the second frame discriminator detects the arrival of the reply data frame from outside while the second request frame transmission flag register retains the record that the CPU module has transmitted a request data frame;

a second reply frame reception flag register in which the fact that a reply data frame has arrived from outside, is recorded by the second frame discriminator when the second frame discriminator detects the arrival of the reply data frame from outside while the second request frame circulation flag register retains the record that the reply data frame has arrived from outside; and

a timer for measuring the time interval between the instant that the CPU module transmits a request data frame and the instant that the CPU module receives a reply data frame.

According to this CPU unit, it can be made easy to locate the positions of abnormalities in the ring-shaped network by checking the time-out in the ring-shaped network with the three flag registers.

According to this invention, a communication apparatus and a control system can be provided which can improve availability and locate the positions of abnormalities.

Other objects, features and advantages of the invention will become apparent from the following description of the embodiments of the invention taken in conjunction with the accompanying drawings.

### BRIEF DESCRIPTION OF THE DRAWINGS

FIG. 1 shows in block diagram the entire structure of a plant control system as an embodiment of this invention;

FIG. 2 shows in block diagram an active CPU unit used in the plant control system shown in FIG. 1;

FIG. 3 illustrates the format of a data frame used according to this invention;

FIGS. 4A and 4B show tables listing the contents of flag registers which the command apparatus receives from the active CPU unit, and exemplifies how the contents of flag registers which the command apparatus receives from the active CPU unit, are stored in a RAM (not shown);

FIG. 5 is the flow chart of the operation of the active CPU unit;

FIG. 6 is the communication time chart for the normal operation of the plant control system shown in FIG. 1;

FIG. 7 is the communication time chart for the abnormal operation of the plant control system shown in FIG. 1;

FIG. 8 shows the relationship between the contents of the flag registers belonging to the lines of subsystem 1 and the positions of failure on the lines;

FIG. 9 shows the relationship between the contents of the flag registers belonging to the lines of subsystem 2 and the positions of failure on the lines;

FIG. 10 shows the relationship between the contents of the flag registers belonging to the lines of 1st and 2nd paths and the positions of failure on the lines; and

FIG. 11 shows the relationship between the contents of the flag registers belonging to the lines of 1st and 2nd paths and the positions of abnormalities.

### DETAILED DESCRIPTION OF THE INVENTION

### Entire System

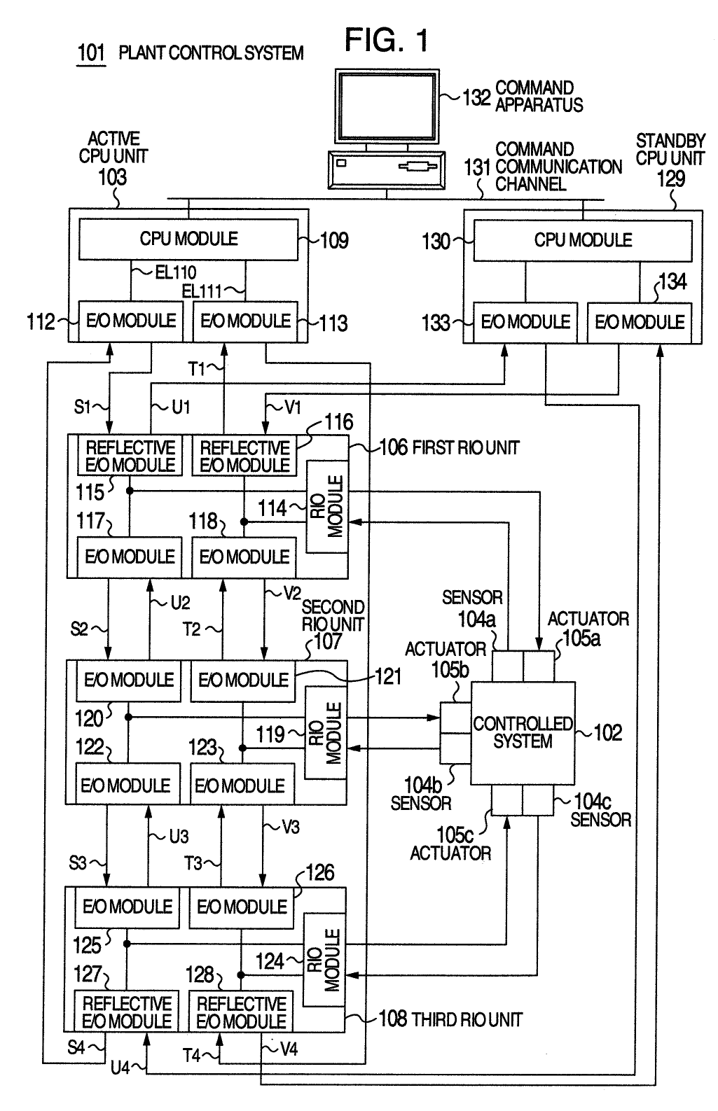

An overall plant control system as an embodiment of this invention will be described below in reference to FIGS. 1 through 5.

FIG. 1 shows in block diagram the entire structure of a plant control system as an embodiment of this invention.

A plant control system 101 serves to perform suitable controls over a controlled system 102.

The controlled system 102 is controlled by the data frames transmitted by an active CPU 103 and also reflects the signals generated by plural sensors 104a, 104b and 104c installed in a controlled system 102, to the following control cycles where the active CPU unit 103 receives the signals and thereby controls actuators 105a, 105b and 105c.

As shown in FIG. 1, three remote input/output units (hereafter referred to as RIO units) such as a first RIO unit 106, a second RIO unit 107 and a third RIO unit 108, are disposed between the active CPU 103 and the controlled system 102, as interfaces for the sensors 104a, 104b and 104c and the actuators 105a, 105b and 105c.

The number of RIO units is adjusted depending on the number of actuators and sensors installed in the controlled system 102.

In the plant control system 101, control lines through which the control signals are transmitted and received, are duplicated.

In the active CPU unit 103, two control lines EL110 and EL111 connect a CPU module 109 with electro-optical modules 112 and 113, respectively. That is, the control line EL110 is connected with the electro-optical module 112 and the control line EL111 is connected with the electro-optical module 113 having the same structure as the electro-optical module 112. In FIG. 1, the electro-optical module is referred to as “E/O module” for brevity. Further, the control lines EL110 and EL111 are referred to hereafter as “line of 1st path” and “line of 2nd path, respectively.

The electro-optical module 112 may be a kind of photoelectric transducer which uses an optical cable and is well-known in the field of network. The electro-optical module 112 is electrically connected with the CPU module 109 while it is coupled to the first RIO unit 106 and the third RIO unit 108 by means of optical cables. The electro-optical module 112 receives an optical signal via one optical cable, converts the inputted optical signal into an electric signal, and outputs the electric signal. On the other hand, when the electro-optical module 112 receives an electric signal, it converts the electric signal into an optical signal and transmits the optical signal via the other optical cable.

The CPU module 109 transmits the same request data frames via the control line EL110 belonging to the line of 1st path and the control line EL111 belonging to the line of 2nd path. Thereafter, the CPU module 109 receives through both the lines of 1st and 2nd paths the reply data frames transmitted by the RIO module in the RIO unit, the RIO module being described later.

The first RIO unit 106 and the third RIO unit 108 have the same internal structure as each other. The internal structure of the RIO unit is described with the first RIO unit 106 taken as an example.

In the first RIO unit 106, two control lines, i.e. lines of 1st and 2nd paths, are drawn from a remote I/O module (referred to hereafter as “RIO module”) 114.

A reflective electro-optical transducer module 115 is connected between the RIO module 114 and the E/O module 112 which is in turn connected via the line of 1st path with the CPU module 109.

A reflective electro-optical transducer module 116 having the same internal structure as the reflective electro-optical transducer module 115, is connected between the RIO module 114 and the E/O module 113 which is in turn connected via the line of 2nd path with the CPU module 109.

In FIG. 1, the reflective electro-optical transducer modules 115 and 116 are referred to as “reflective E/O modules” for brevity.

The RIO module 114 is connected with an electro-optical transducer module 117 having the same internal structure as the electro-optical transducer module 112 in the active CPU unit 103, and the electro-optical transducer module 117 which is in turn connected with the second RIO unit 107 via the line of 1st path.

Also, the RIO module 114 is connected with an electro-optical transducer module 118 having the same internal structure as the electro-optical transducer module 117, and the electro-optical transducer module 118 is in turn connected with the second RIO unit 107 via the line of 2nd path.

The reflective electro-optical transducer module 115 is similar in function to the above-mentioned electro-optical transducer module 112 and is a sort of photoelectric transducer which uses an optical cable and well-known in the field of network. The difference from the electro-optical transducer module 112 is that the reflective electro-optical transducer module 115 receives a signal through one optical cable and transmits the signal through the other optical cable.

In fact, the first RIO unit 106 and the third RIO unit 108 are connected with the active CPU unit 103 by way of the reflective electro-optical transducer modules while the first RIO unit 106 and the third RIO unit 108 are connected with the second RIO unit 107 by way of the electro-optical modules.

Simply put, the second RIO unit 107 is connected between the first RIO unit 106 and the third RIO unit 108.

The internal structure of the second RIO unit 107 is similar to those of the first RIO unit 106 and the third RIO unit 108 except that the reflective electro-optical transducer modules are replaced by the electro-optical transducer modules.

Two optical cables are connected with each of all the electro-optical and reflective electro-optical transducer modules. One of the two optical cables is dedicated to the transmission of data frames while the other is dedicated to the reception of data frames. It is to be noted here that those terminals of the electro-optical and reflective electro-optical transducer modules which are connected with the optical cable dedicated to data frame transmission are referred to hereafter as “transmission terminals” and that those terminals of the electro-optical and reflective electro-optical transducer modules which are connected with the optical cable dedicated to data frame reception are referred to hereafter as “reception terminals”.

The connections between the active CPU unit 103 and the first RIO unit 106, and between the active CPU unit 103 and the third RIO unit 108 are made through optical cables, and also the connections between the second RIO unit 107 and the first RIO unit 106, and between the second RIO unit 107 and the third RIO unit 108 are made through optical cables.

The transmission terminal of the electro-optical transducer module 112 connected with the line of 1st path in the active CPU unit 103 is connected via an optical cable S1 with the reception terminal of the reflective electro-optical transducer module 115 connected with the line of 1st path in the first RIO unit 106.

The transmission terminal of the electro-optical transducer module 117 connected with the line of 1st path in the first RIO unit 106 is connected via an optical cable S2 with the reception terminal of the electro-optical transducer module 120 connected with the line of 1st path in the second RIO unit 107.

The transmission terminal of the electro-optical transducer module 122 connected with the line of 1st path in the second RIO unit 107 is connected via an optical cable S3 with the reception terminal of the electro-optical transducer module 125 connected with the line of 1st path in the third RIO unit 108.

The transmission terminal of the electro-optical transducer module 127 connected with the line of 1st path in the third RIO unit 108 is connected via an optical cable S4 with the reception terminal of the electro-optical transducer module 112 connected with the line of 1st path in the active CPU unit 103.

As described above, signals start from the active CPU unit 103, proceed through the first, second and third RIO units 106, 107 and 108, and returns to the active CPU unit 103. In other words, the line of 1st path forms a loop.

The request data frame transmitted from the active CPU unit 103 passes through the line of 1st path, following the path mentioned above, and reaches the RIO unit regarded as destination. The reply data frame transmitted from one of the RIO units passes through the line of 1st path, following the path mentioned above, and reaches the active CPU unit 103 regarded as destination.

The reception terminal of the electro-optical module 117 connected with the line of 1st path in the first RIO unit 106 is connected via an optical cable U2 with the transmission terminal of the electro-optical module 120 in the second RIO unit 107.

The reception terminal of the electro-optical module 122 connected with the line of 1st path in the second RIO unit 107 is connected via an optical cable U3 with the transmission terminal of the electro-optical module 125 in the third RIO unit 108. These optical cables which conduct signals in the direction opposite to the direction of signals traveling through the loop of the line of 1st path, are provided so that a standby UPU unit 129 connected with the transmission terminal of the reflective electro-optical transducer module 115 connected with the line of 1st path in the first RIO unit 106 may snoop data frames, and that request data frames and reply data frames may be transferred to the line of 1st path when the active CPU unit 103 fails and therefore is taken over by the standby CPU unit 129.

The transmission terminal of the electro-optical transducer module 113 connected with the line of 2nd path in the active CPU unit 103 is connected via an optical cable T4 with the reception terminal of the reflective electro-optical transducer module 128 connected with the line of 2nd path in the third RIO unit 108.

The transmission terminal of the electro-optical transducer module 126 connected with the line of 2nd path in the third RIO unit 108 is connected via an optical cable T3 with the reception terminal of the electro-optical transducer module 123 connected with the line of 2nd path in the second RIO unit 107.

The transmission terminal of the electro-optical transducer module 121 connected with the line of 2nd path in the second RIO unit 107 is connected via an optical cable T2 with the reception terminal of the electro-optical transducer module 118 connected with the line of 2nd path in the first RIO unit 106.

The transmission terminal of the reflective electro-optical transducer module 116 connected with the line of 2nd path in the first RIO unit 106 is connected via an optical cable T1 with the reception terminal of the electro-optical transducer module 113 connected with the line of 2nd path in the active CPU unit 103.

As described above, signals start from the active CPU unit 103, proceed through the third, second and first RIO units 108, 107 and 106, and returns to the active CPU unit 103. In other words, the line of 2nd path forms a loop.

The request data frame transmitted from the active CPU unit 103 passes through the line of 2nd path, following the path mentioned above, and reaches the RIO unit regarded as destination. The reply data frame transmitted from one of the RIO units passes through the line of 2nd path, following the path mentioned above, and reaches the active CPU unit 103 regarded as destination.

The reception terminal of the electro-optical module 126 connected with the line of 2nd path in the third RIO unit 108 is connected via an optical cable V3 with the transmission terminal of the electro-optical module 123 in the second RIO unit 107.

The reception terminal of the electro-optical module 121 connected with the line of 2nd path in the second RIO unit 107 is connected via an optical cable V2 with the transmission terminal of the electro-optical module 118 in the first RIO unit 106.

These optical cables which conduct signals in the direction opposite to the direction of signals traveling through the loop of the line of 2nd path, are provided so that the standby UPU unit 129 connected with the transmission terminal of the reflective electro-optical transducer module 128 connected with the line of 2nd path in the third RIO unit 108 may snoop data frames, and that request data frames and reply data frames may be transferred to the line of 2nd path when the active CPU unit 103 fails and therefore is taken over by the standby CPU unit 129.

As apparent from the foregoing description, each of the lines of 1st and 2nd paths forms a ring, and the data frames transmitted from the active CPU unit 103 or each of the RIO units travel in the opposite directions depending on whether they travel through the line of 1st path or the line of 2nd path. This configuration where data frames can be transmitted in the opposite directions through the two lines of 1st and 2nd paths, can enhance the ability to cope with failures that may occur in the plant control system as a whole.

An example of such enhanced ability will be described below.

Description is made of how communication between the active CPU unit 103 and the second RIO unit 107 can be realized in the case where all of the four optical cables S2, U2, T2 and V2, which connect the first RIO unit 106 with the second RIO unit 107, are cut off.

In this case, the request data frame transmitted from the active CPU unit 103 cannot reach the second RIO unit 107 via the line of 1st path since the optical cable S2 is cut off. However, it can reach the second RIO unit 107 via the line of 2nd path. Similarly, although the reply data frame transmitted from the second RIO unit 107 cannot reach the active CPU unit 103 via the line of 2nd path since the optical cable T2 is cut off, it can reach the active CPU unit 103 via the line of 1st path.

Sufficient availability cannot be achieved in any conventional, non-ring type network system wherein line duplication is employed, when all the optical cables forming the signal paths are cut off. According to the plant control system 101 as an embodiment of this invention, a network of double-ring configuration is employed and data frames can travel in two opposite directions. Accordingly, even if all the lines are cut off at any point in the signal paths, data frames can be sent from the originating site to the terminating site, or vice versa.

As another example is described the case where communication is attempted between the active CPU unit 103 and the second RIO unit 107 when all the four optical cables (S1 and U1 connected with the reflective electro-optical transducer module 115 in the first RIO unit 106, and T1 and V1 connected with the reflective electro-optical transducer module 116 in the first RIO unit 106) are cut off.

In this case, too, as described in the above exemplary case where all of the four optical cables S2, U2, T2 and V2, which connect the first RIO unit 106 with the second RIO unit 107, are cut off, although the request data frame transmitted from the active CPU unit 103 cannot reach the second RIO unit 107 via the line of 1st path since the optical cable S1 is cut off, it can reach the second RIO unit 107 via the line of 2nd path. Similarly, although the reply data frame transmitted from the second RIO unit 107 cannot reach the active CPU unit 103 via the line of 2nd path since the optical cable T1 is cut off, it can reach the active CPU unit 103 via the line of 1st path.

In a still another example where all the four optical cables, S1 and S4 connected with the electro-optical transducer module 112, and T1 and T4 connected with the electro-optical transducer module 113, in the active CPU unit 103, are cut off, what will happen? In such a case, the standby CPU unit 129 will start operating in place of the active CPU unit 103.

As described above, with the plant control system 101 as an embodiment of this invention, even if four optical cables at most are cut off with respect to the active CPU unit, the standby CPU unit and all the RIO units, communication can be maintained.

In general, line failures tend to occur in a concentrated manner at some point in the system. The plant control system as an embodiment of this invention exhibits a high immunity to such concentrated failures so that high availability can be achieved.

The excellent availability of the plant control system 101 as an embodiment of this invention has been described in reference to FIG. 1. However, the plant control system 101 requires not only its high availability but also a high capability of restoring the proper function of the system when the system fails. The mere maintenance of communication function might not eliminate a fatal communication accident that may follow a certain failure. Therefore, it is necessary for the operators to immediately grasp the information on the spot of failure as well as the fact that a failure has occurred.

According to the plant control system 101 as an embodiment of this invention, a high capability of detecting failures can be achieved by using the nature of a ring-shaped network. The details of the plant control system 101 as an embodiment of this invention, along with its capability of detecting failures, will now be described.

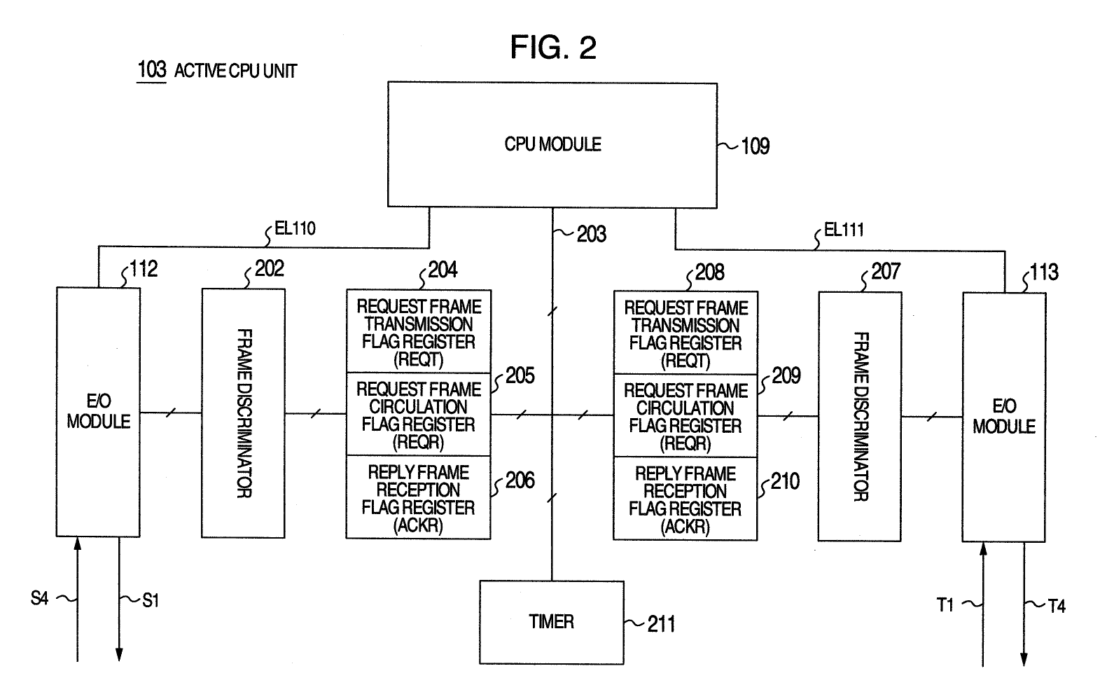

FIG. 2 shows in block diagram the active CPU unit 103 used in the plant control system 101 shown in FIG. 1. As mentioned above, the active CPU unit 103 and the standby CPU unit 129 have the same internal structure, and in what follows the CPU units are described with the active CPU unit 103 as an illustrative example.

The active CPU unit 103 executes a sequence control or a feedback control over the controlled system 102. For this purpose, the CPU module 109 generates a request data frame to be sent to a specified RIO unit corresponding to that portion of the controlled system 102 which needs to be actually controlled; transmits the generated request data frame via the lines of 1st and 2nd paths simultaneously; and receives a reply data frame transmitted by the specified RIO unit. A control line EL110 belonging to the line of 1st path of the CPU module 109 is connected with the electro-optical transducer module 112, which is in turn connected with a frame discriminator 202. The frame discriminator 202 discriminates the kinds, or contents, or data frames and operates one of three flag resisters depending on the result of discrimination.

Before transmitting a request data frame, the CPU module 109 previously initializes the logical contents of a request frame transmission flag register 204, a request frame circulation flag register 205 and a reply frame reception flag register 206 through a bus 203, so that they become all “false”.

Then, when the CPU module 109 transmits a request data frame to the interested RIO unit, the frame discriminator 202 changes the logical content of the request frame transmission flag register 204 from “false” to “true” (that is, the flag is raised). At this time, the frame discriminator 202 ascertains that the logical content of the request frame circulation flag register 205 is “false” (that is, the flag is taken down) and recognizes that the request data frame is what was transmitted from the CPU module 109 to the interested RIO unit.

When the request data frame is returned to the CPU module 109 via the RIO units, traveling through the loop of the line of 1st path, the frame discriminator 202 changes the logical content of the request frame circulation flag register 205 from “false” to “true” (that is, the flag is raised). At this time, the frame discriminator 202 ascertains that the logical content of the request frame transmission flag register 204 is “true”, and recognizes that the request data frame is what was returned from the interested RIO unit to the CPU module 109 (i.e. what is to be received by the CPU module 109).

When a reply data frame is transmitted from a RIO unit to the CPU module 109, the frame discriminator 202 changes the logical content of the reply frame reception register 206 from “false” to “true” (that is, the flag is raised).

As described above, while all the optical cables and all the RIO units constituting the plant control system 101 are in the condition of normal communication, the frame discriminator 202 raises the flags of the request frame transmission flag register 204, the request frame circulation flag register 205 and the reply frame reception flag register 206 in this order named.

The foregoing description is dedicated to the functional blocks connected with the line of 1st path. The same functional blocks as are connected with the line of 1st path, such as the electro-optical transducer module 112, the frame discriminator 202, the request frame transmission flag register 204, the request frame circulation flag register 205 and the reply frame reception flag register 206, are also connected with the line of 2nd path. These functional blocks connected with the line of 2nd path operate exactly in the same manner as those connected with the line of 1st path.

A timer 211 is connected with the bus 203 so as to measure the time for monitoring the request frame transmission flag register 204, the request frame circulation flag register 205, or the reply frame reception flag register 206. Firstly, the CPU module 109 initializes the request frame transmission flag register 204, the request frame circulation flag register 205 and the reply frame reception flag register 206, transmits a request data frame, and drives the timer 211 into operation. After the timer 211 has measured a predetermined length of time, the CPU module 109 ascertains the contents of the request frame transmission flag register 204, the request frame circulation flag register 205 and the reply frame reception flag register 206. If the flags of all these registers are raised within the predetermined length of time, it is considered that the request data frame has been normally transmitted.

The CPU module 109 transmits the contents of these three flag registers to a command apparatus 132 via a command communication channel 131. On the basis of the contents of the flag registers, the command apparatus 132 analyzes whether the network in use is currently normal or abnormal, or where the point of abnormality is located, as precisely as possible, and then notifies the operator(s) of the abnormal condition.

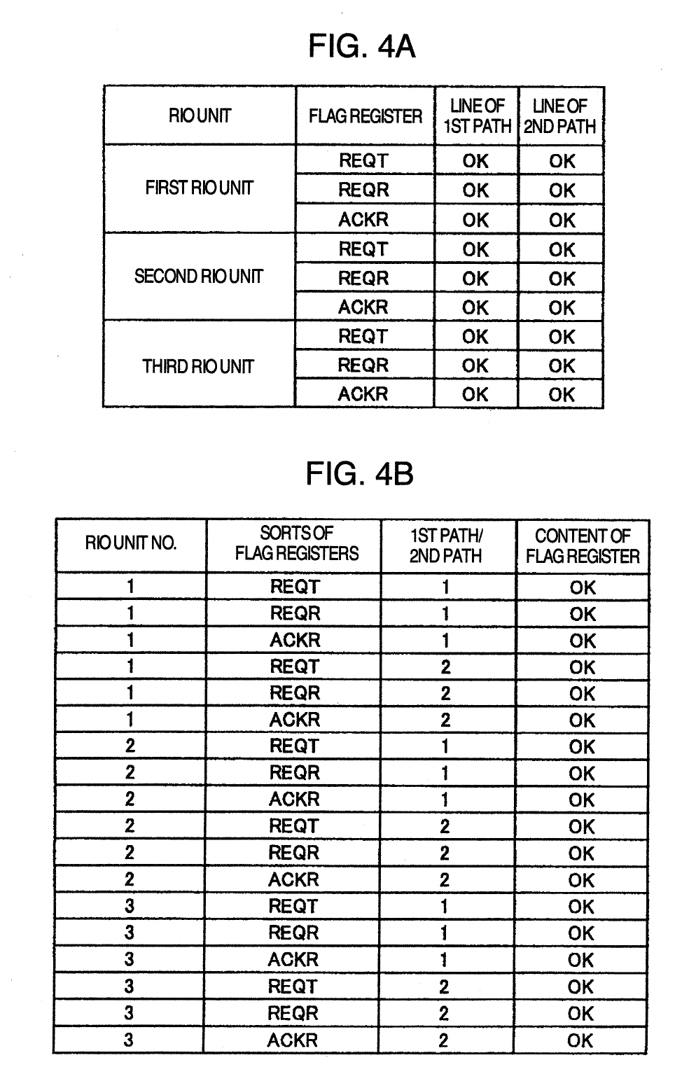

In FIG. 2, and likewise in FIGS. 4A, 4B, 8, 9, 10 and 11, the request frame transmission flag register 204, the request frame circulation flag register 205 and the reply frame reception flag register 206 are referred to as “REQT”, “REQR” and “ACKR”, respectively.

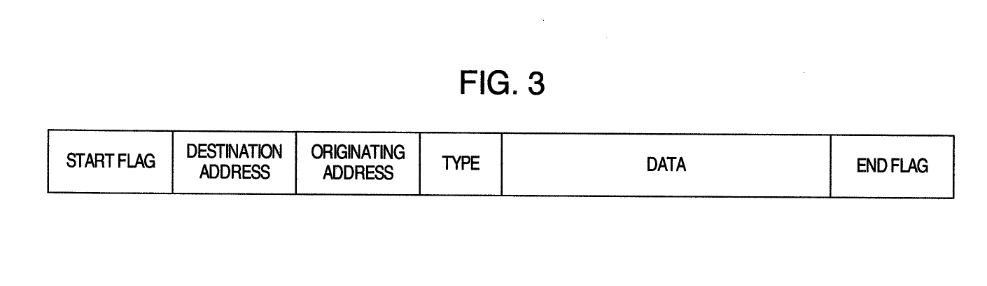

FIG. 3 illustrates the format of a data frame used according to this invention. The data frame consists of such blocks as a “start flag”, a “terminating or destination address”, an “originating address”, a “type”, “data”, and an “end flag”, arranged from head to tail in this order.

The “start flag” heads the data frame and is made up of a particular set of bits different from all the other frame blocks. The CPU module 109 and the RIO units detect this start flag and recognize that a data frame has arrived.

The “destination address” is that which indicates the destination to which the data frame is to be delivered. The CPU module 109 or the RIO units receive the destination address if it coincides with their addresses, but do not receive it if it does not coincide with their addresses. It is to be noted here that all the CPU modules 109 and all the RIO units have their unique addresses among which there is no duplication.

The “originating address” is that which indicates the site from which the data frame is originally transmitted. In other words, the CPU or the RIO unit which sends out a data frame, has the unique address of its own set in this block of “originating address”.

The “type” serves to discriminate between the request data frame (REQ) and the reply data frame (ACK). The CPU module 109 (line parent station) transmits a request data frame and each RIO unit (line daughter station), which is to reply, answers with a reply frame.

The “data” is the block in which input or output data are written.

The “end flag” indicates the end of the frame. This “end flag”, like the “start flag”, consists of a unique set of bits that are different from the set of bits constituting any other block of the frame.

FIG. 4A is a table which lists the contents of flag registers that the command apparatus 132 receives from the active CPU unit 103. FIG. 4B illustrates how the contents of flag registers that the command apparatus 132 receives from the active CPU unit 103, are stored in a RAM (not shown).

The command apparatus 132, as shown in FIG. 4A, reads out the contents of the request frame transmission flag register 204, the request frame circulation flag register 205 and the reply frame reception flag register 206 with respect to the first, second and third RIO units 106, 107 and 108, for lines of 1st and 2nd paths.

The RAM (not shown) in the command apparatus 132 stores the contents of these flag registers in the form of a table, as shown in FIG. 4B, containing four fields such as a “RIO unit number” field, a “kind of flag register” field, a “line of 1st or 2nd path” field, and a “flag register content” field. Alternatively, the RAM may store the contents of the flag registers as the values of three array variables whose arguments are “RIO number”, “kinds of flag registers”, and “kinds of lines of 1st and 2nd paths”. The “RIO unit number” field is provided to store the addresses of the RIO units, but the field is not named “RIO unit address” field for the simplicity of description.

The labels “OK” in the flag register content columns of the tables shown in FIGS. 4A and 4B indicate that the content of the related flag register is logically “true”.

### <<Operation>>

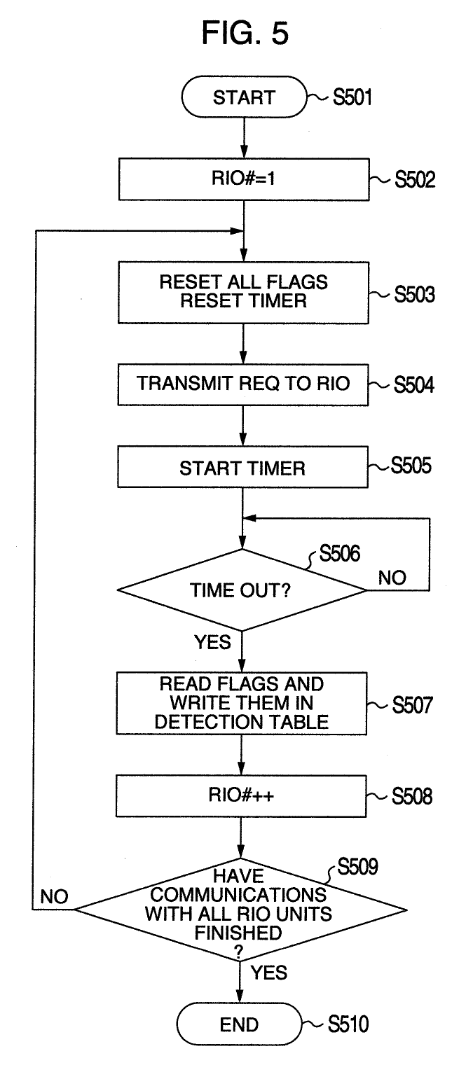

FIG. 5 is the flow chart of the operation of the active CPU unit 103. In order to swiftly grasp the conditions of lines connecting the active CPU unit 103 to the respective RIO units, the active CPU unit 103 generates a dummy request data frame indicating “non-execution” even when there is no object to be controlled in the controlled system, and sends out the dummy request data frame to the RIO units. This is a so-called polling that is well-known.

When the process is initiated (S501), the CPU module 109 specifies the first RIO unit as a target to which the request data frame is initially transmitted (S502).

After this, a series of operations form a loop. Now, the CPU module 109 initializes the logical contents of the request frame transmission flag registers 204 and 208, the request frame circulation flag registers 205 and 209, and the reply frame reception flag registers 206 and 210 belonging to the lines of 1st and 2nd paths, all to “false” and simultaneously resets the timer 211 (S503). Then, the CPU module 109 transmits the request data frame to the RIO unit that has been specified as a target for transmission (S504) and starts up the timer 211 (S505).

The CPU module 109 monitors the timer 211 that was started up in the step S505 and checks whether or not a predetermined length of time has elapsed (S506). If the predetermined length of time has elapsed (YES in S506), the CPU module 109 reads out the contents of the request frame transmission flag register 204, the request frame circulation flag register 205 and the reply frame reception flag register 206 all connected with the line of 1st path, and the contents of the request frame transmission flag register 208, the request frame circulation flag register 209 and the reply frame reception flag register 210 all connected with the line of 2nd path. Further, the CPU module 109 writes the read contents in the detection table defined in the RAM (not shown) installed therein (S507) and specifies the next RIO unit as the next target for request data frame transmission (S508).

The CPU module 109 checks whether or not it has completed communication with all the RIO units (S509). If there remains any RIO unit with which the CPU module 109 has not yet completed communication (NO in S509), the step S503 is resumed to repeat the same process. If communications with all the RIO units have been completed (YES in S509), the CPU module 109 finishes the series of operations (S510).

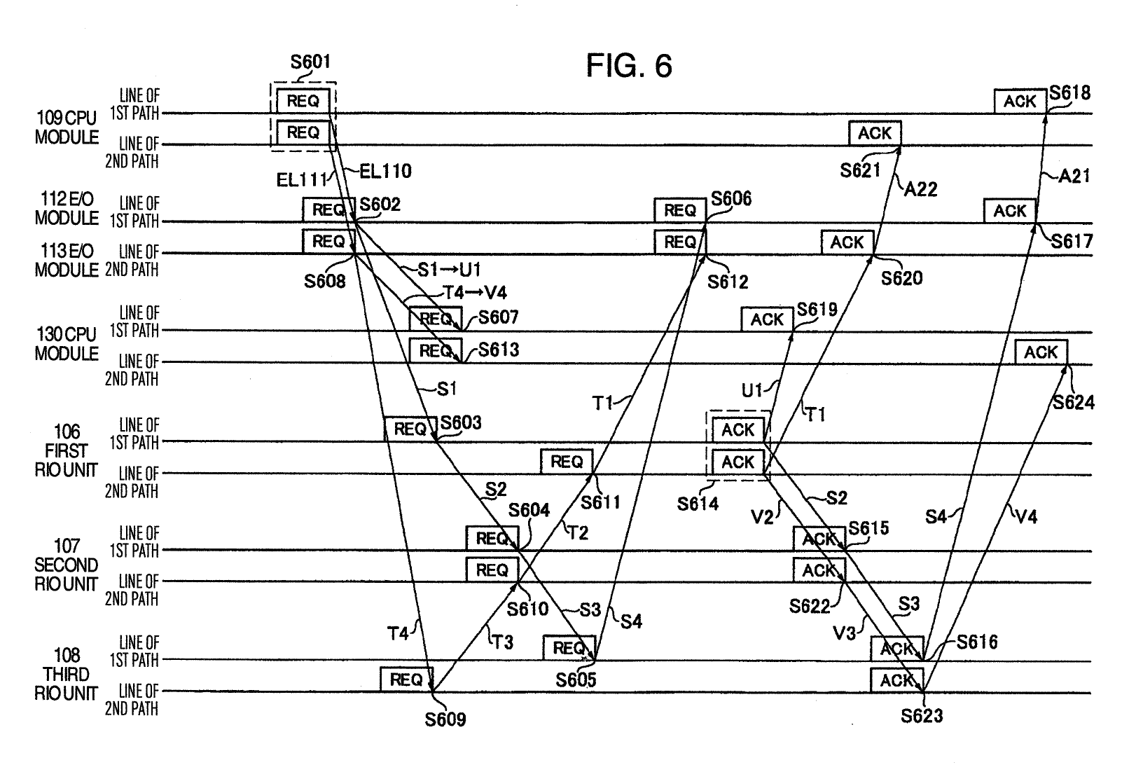

FIG. 6 is the communication time chart for the normal operation of the plant control system 101 shown in FIG. 1. As shown in FIG. 6, under the condition that all the CPU units, all the RIO units and all the lines are sound, the active CPU unit 103 transmits a request data frame to the first RIO unit 106; the first RIO unit 106 in turn transmits a reply data frame; and the transmitted reply data frame reaches the active CPU unit 103. In FIG. 6, “REQ” represents a request data frame, and “ACK” a reply data frame.

### [Transmission of Request Data Frame]

The CPU module 109 sends out the same request data frames onto the lines of 1st and 2nd paths, simultaneously (S601).

The request data frame sent out by the CPU module 109 reaches the electro-optical transducer module 112 through the control line EL110 which belongs to the line of 1st path (S602). At this time, the frame discriminator 202 changes the content of the request frame transmission flag register 204 to logical “true” (the flag is raised).

The request data frame relayed by the electro-optical transducer module 112 of the active CPU unit 103 reaches the reflective electro-optical transducer module 115 in the first RIO unit 106 through the optical cable S1 (S603).

The request data frame relayed by the reflective electro-optical transducer module 115 in the first RIO unit 106 reaches the RIO module 114 and also the electro-optical transducer module 117 in the first RIO unit 106. At this time, the RIO module 114 recognizes that its own address coincides with the destination address in the request data frame; interprets the command included in the data; and executes the command. As a result of the RIO module 114 having executed the data in the request data frame, the executed result obtained from the sensor 104a serves as a reply frame that will be described later.

The request data frame relayed by the electro-optical transducer module 117 in the first RIO unit 106 reaches the electro-optical transducer module 120 in the second RIO unit 107 through the optical cable S2 (S604).

The request data frame relayed by the electro-optical transducer module 120 in the second RIO unit 107 reaches the RIO module 119 and also the electro-optical transducer module 122 in the second RIO unit 107. At this time, the RIO module 119 recognizes that its own address is not coincident with the destination address in the request data frame, and discards the request data frame as a result of this recognition.

The request data frame relayed by the electro-optical transducer module 122 in the second RIO unit 107 reaches the electro-optical transducer module 125 in the third RIO unit 108 through the optical cable S3 (S605).

The request data frame relayed by the electro-optical transducer module 125 in the third RIO unit 108 reaches the RIO module 124 and also the reflective electro-optical transducer module 127 in the third RIO unit 108. At this time, the RIO module 124 recognizes that its own address is not coincident with the destination address in the request data frame, and discards the request data frame as a result of this recognition.

The request data frame relayed by the reflective electro-optical transducer module 127 in the third RIO unit 108 reaches the electro-optical transducer module 112 in the active CPU unit 103 through the optical cable S4 (S606). At this time, the frame discriminator 202 changes the logical content of the request frame circulation flag register 205 to “true” (the flag is raised), and discards the request data frame without sending it to the CPU module 109.

As described above, the request data frame transmitted from the active CPU unit 103 is relayed by the first, second and third RIO units 106, 107 and 108 in this order named through the line of 1st path, and returned to the active CPU unit 103 to be discarded by the electro-optical transducer module 112 therein.

On the other hand, after the step S602, the reflective electro-optical transducer module 115 in the first RIO unit 106 sends out the request data frame received from the electro-optical transducer module 112 in the active CPU unit 103, also to the electro-optical transducer module 133 in the standby CPU unit 129 through the optical cable U1 (S607). As a result of this operation, the standby CPU unit 129 can perform the snooping of the request data frame on the line of 1st path.

After the step S601, the request data frame transmitted from the CPU module 109 reaches the electro-optical transducer module 113 through the control line EL111 belonging to the line of 2nd path (S608). At this time, the frame discriminator 202 changes the logical content of the request frame transmission flag register 208 to “true” (the flag is raised).

The request data frame relayed by the electro-optical transducer module 113 in the active CPU unit 103 reaches the reflective electro-optical transducer module 128 in the third RIO unit 108 through the optical cable T4 (S609).

The request data frame relayed by the reflective electro-optical transducer module 128 in the third RIO unit 108 reaches the RIO module 124 and also the electro-optical transducer module 126 in the third RIO unit 108. At this time, the RIO module 124 recognizes that its own address is not coincident with the destination address in the request data frame, and discards the request data frame as a result of this recognition.

The request data frame relayed by the electro-optical transducer module 126 in the third RIO unit 108 reaches the electro-optical transducer module 123 in the second RIO unit 107 through the optical cable T3 (S610).

The request data frame relayed by the electro-optical transducer module 123 in the second RIO unit 107 reaches the RIO module 119 and also the electro-optical transducer module 121 in the second RIO unit 108. At this time, the RIO module 119 recognizes that its own address is not coincident with the destination address in the request data frame, and discards the request data frame as a result of this recognition.

The request data frame relayed by the electro-optical transducer module 121 in the second RIO unit 107 reaches the electro-optical transducer module 118 in the first RIO unit 106 through the optical cable T2 (S611).

The request data frame relayed by the electro-optical transducer module 118 in the first RIO unit 106 reaches the RIO module 114 and also the reflective electro-optical transducer module 116 in the first RIO unit 106. At this time, the RIO module 114 recognizes that its own address coincides with the destination address in the request data frame; interprets the command included in the data; and executes the command. As a result of the RIO module 114 having executed the data in the request data frame, the executed result obtained from the sensor 104a serves as a reply frame that will be described later.

The request data frame relayed by the reflective electro-optical transducer module 116 in the first RIO unit 106 reaches electro-optical transducer module 113 in the active CPU unit 103 (S612). At this time, the frame discriminator 202 changes the logical content of the request frame circulation flag register 209 to “true” (the flag is raised), and discards the request data frame without sending it to the CPU module 109.

As described above, the request data frame transmitted from the active CPU unit 103 is relayed by the third, second and first RIO units 108, 107 and 106 in this order named through the line of 2nd path, and returned to the active CPU unit 103 to be discarded by the electro-optical transducer module 113 therein.

On the other hand, after the step S611, the reflective electro-optical transducer module 128 in the third RIO unit 108 sends out the request data frame received from the electro-optical transducer module 113 in the active CPU unit 103, also to the electro-optical transducer module 134 in the standby CPU unit 129 through the optical cable V4 (S613). As a result of this operation, the standby CPU unit 129 can perform the snooping of the request data frame on the line of 2nd path.

### [Reception of Reply Data Frame]

The RIO module 114 in the first RIO unit 106 which received two request data frames in the previous steps S603 and S611, reads one of them, received in the step S603, and executes control accordingly. Then, upon receiving the executed result from the sensor 104a, the RIO module 114 converts the result into data, generates a reply data frame from the data, and transmits the generated reply data frame onto the lines of 1st and 2nd paths, simultaneously (S614).

The reply data frame transmitted by the RIO module 114 in the first RIO unit 106 reaches the electro-optical transducer module 117 and the reflective electro-optical transducer module 115 through the line of 1st path.

The reply data frame relayed by the electro-optical transducer module 117 in the first RIO unit 106 reaches the electro-optical transducer module 122 in the second RIO unit 107 through the optical cable S2 (S615).

The reply data frame relayed by the electro-optical transducer module 120 in the second RIO unit 107 reaches the RIO module 119 and also the electro-optical transducer module 122 in the second RIO 107. At this time, the RIO module 119 recognizes that its own address is not coincident with the destination address in the reply data frame, and discards the reply data frame as a result of this recognition.

The reply data frame relayed by the electro-optical transducer module 122 in the second RIO unit 107 reaches the electro-optical transducer module 125 in the third RIO unit 108 through the optical cable S3 (S616).

The reply data frame relayed by the electro-optical transducer module 125 in the third RIO unit 108 reaches the RIO module 124 and also the reflective electro-optical transducer module 127 in the third RIO unit 108. At this time, the RIO module 124 recognizes that its own address is not coincident with the destination address in the reply data frame, and discards the reply data frame as a result of this recognition.

The reply data frame relayed by the reflective electro-optical transducer module 127 in the third RIO unit 108 reaches the electro-optical transducer module 112 in the active CPU unit 103 through the optical cable S4 (S617). Then, the frame discriminator 202 changes the logical content of the reply frame reception flag register 206 to “true” (the flag is raised), and sends the rely data frame to the CPU module 109 (S618).

As described above, the reply data frame transmitted from the first RIO unit 106 is relayed by the second and third RIO units 107 and 108 in this order named through the line of 1st path, and returned to the CPU module 109 in the active CPU unit 103.

On the other hand, after the step S614, the reflective electro-optical transducer module 115 in the first RIO unit 106 sends out the reply data frame received from the RIO module 114 in the first RIO unit 106, also to the electro-optical transducer module 133 in the standby CPU unit 129 through the optical cable U1 (S619). As a result of this operation, the standby CPU unit 129 can perform the snooping of the reply data frame on the line of 1st path.

After the step S614, the reply data frame transmitted from the RIO module 114 in the first RIO unit 106 reaches the reflective electro-optical transducer module 116 and the electro-optical transducer module 118 through the line of 2nd path.

The reply data frame relayed by the reflective electro-optical transducer module 116 in the first RIO unit 106 reaches the electro-optical transducer module 113 in the active CPU unit 103 through the optical cable T1 (S620). Then, the frame discriminator 207 changes the logical content of the reply frame reception flag register 210 to “true” (the flag is raised), and transmits the reply data frame to the CPU module 109 (S621).

On the other hand, after the step S614, the reply data frame relayed by the electro-optical transducer module 118 in the first RIO unit 106 reaches the electro-optical transducer module 121 in the second RIO unit 107 through the optical cable V2 (S622).

The reply data frame relayed by the electro-optical transducer module 121 in the second RIO unit 107 reaches the RIO module 119 and also the electro-optical transducer module 123 in the second RIO unit 107. At this time, the RIO module 119 recognizes that its own address is not coincident with the destination address in the reply data frame, and discards the reply data frame as a result of this recognition.

The reply data frame relayed by the electro-optical transducer module 123 in the second RIO unit 107 reaches the electro-optical transducer module 126 in the third RIO unit 108 through the optical cable V3 (S623).

The reply data frame relayed by the electro-optical transducer module 126 in the third RIO unit 108 reaches the RIO module 124 and also the reflective electro-optical transducer module 128 in the third RIO unit 108. At this time, the RIO module 124 recognizes that its own address is not coincident with the destination address in the reply data frame, and discards the reply data frame as a result of this recognition.

The reply data frame relayed by the reflective electro-optical transducer module 128 in the third RIO unit 108 reaches the electro-optical transducer module 134 in the standby CPU unit 129 through the optical cable V4 (S624).

With this operation, the standby CPU unit 129 can perform the snooping of the reply data frame on the line of 2nd path.

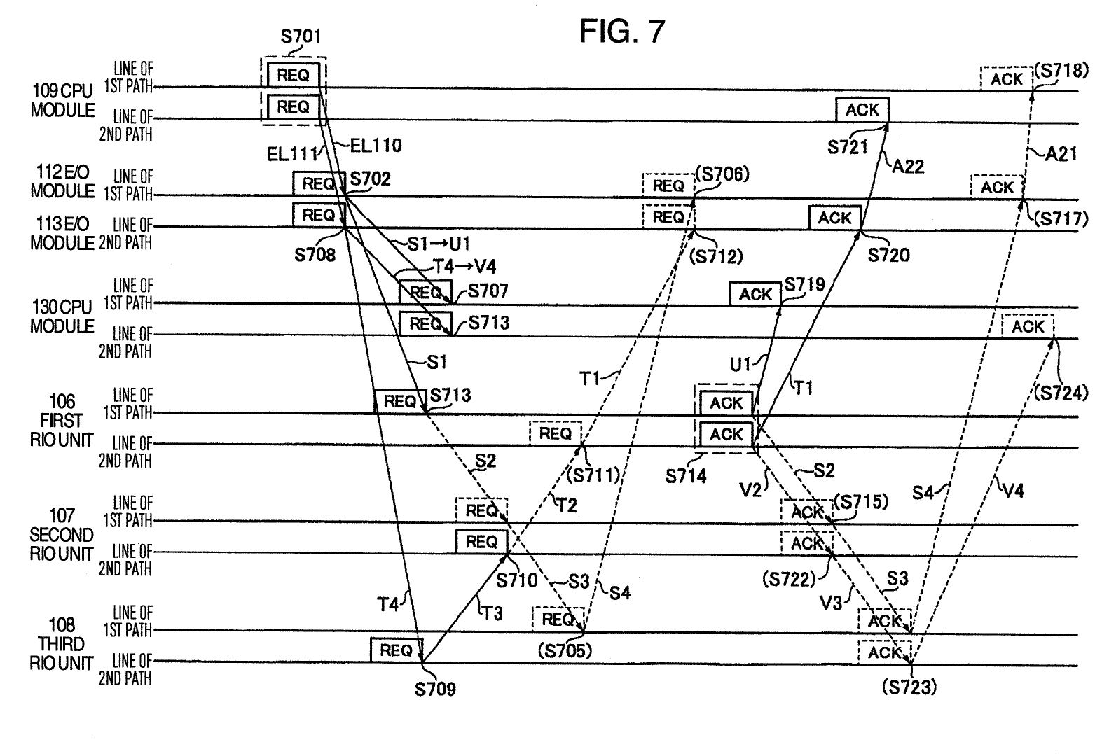

FIG. 7 is the communication time chart for the abnormal operation of the plant control system 101, that is, in the case of a line failure. Although a line failure may occur in any place in the plant control system, the following description is made on the assumption that the four optical cables S2, T2, U2 and V2 connected between the first and second RIO units 106 and 107 are all cut off: And how a request data frame and a reply data frame are relayed through signal paths available, will be explained.

### [Transmission of Request Data Frame]

The CPU module 109 sends out the request data frames having the identical contents to the lines of 1st and 2nd paths, simultaneously (S701).

The request data frame transmitted by the CPU module 109 reaches the electro-optical transducer module 112 through the control line EL110 belonging to the line of 1st path (S702). At this time, the frame discriminator 202 changes the logical content of the request frame transmission flag register 204 to “true” (the flag is raised).

The request data frame relayed by the electro-optical transducer module 112 in the active CPU unit 103 reaches the reflective electro-optical transducer module 115 in the first RIO unit 106 through the optical cable S1 (S703).

The request data frame relayed by the electro-optical transducer module 115 in the first RIO unit 106 reaches the RIO module 114 and also the electro-optical transducer module 117 in the first RIO unit 106. At this time, the RIO module 114 recognizes that its own address coincides with the destination address in the request data frame, interprets the command included in the data, and executes the command. As a result of the RIO module 114 having executed the command in the request data frame, the result of execution obtained from the sensor 104a serves as a reply frame that will be described later.

The request data frame which the electro-optical transducer module 117 in the first RIO unit 106 attempts to transmit, cannot reach the RIO module 119 since the optical cable S2 is cut off. Accordingly, such an operation as performed in the step S604 in FIG. 6 does not take place (S704). After this, such operations as performed in the steps S605 and S606 in FIG. 6 (S705, S706) will not take place, either. As a result, the request data frame does not reach the electro-optical transducer module 112 in the active CPU unit 103. Consequently, the frame discriminator 202 does not change the logical content of the request frame circulation flag register 205 to “true” (the flag remains lowered) within the predetermined length of time measured by the timer 211.

As described above, although the request data frame transmitted from the active CPU unit 103 is relayed to the first RIO unit 106 through the line of 1st path, it cannot return to the active CPU unit 103 by way of the second and third RIO units 107 and 108 since the optical cables are all cut off between them. The CPU module 109 detects this abnormality occurring on the optical cables by recognizing that the flag of the request frame circulation flag register 205 is not raised within the predetermined length of time.

On the other hand, after the step S702, the reflective electro-optical transducer module 115 in the first RIO unit 106 sends the request data frame received from the electro-optical transducer module 112 in the active CPU unit 103, also to the electro-optical transducer module 133 in the standby CPU unit 129 through the optical cable U1 (S707). With this operation, the standby CPU unit 129 can perform the snooping of the request data frame on the line of 1st path. In fact, the line failure assumed in FIG. 7 does not affect the snooping operation itself.

After the step S701, the request data frame transmitted from the CPU module 109 reaches the electro-optical transducer module 113 through the control line EL111 belonging to the line of 2nd path (S708). At this time, the frame discriminator 207 changes the logical content of the request frame transmission flag register 208 to “true” (the flag is raised).

The request data frame relayed by the electro-optical transducer module 113 in the active CPU unit 103 reaches the reflective electro-optical transducer module 128 in the third RIO unit 108 through the optical cable T4 (S709).

The request data frame relayed by the reflective electro-optical transducer module 128 in the third RIO unit 108 reaches the RIO module 124 and also the electro-optical transducer module 126 in the third RIO unit 108. At this time, the RIO module 124 recognizes that its own address is not coincident with the destination address in the request data frame, and discards the request data frame as a result of this recognition.

The request data frame relayed by the electro-optical transducer module 126 in the third RIO unit 108 reaches the electro-optical transducer module 123 in the second RIO unit 107 through the optical cable T3 (S710).

The request data frame relayed by the electro-optical transducer module 123 in the second RIO unit 107 reaches the RIO module 119 and also the electro-optical transducer module 121 in the second RIO unit 107. At this time, the RIO module 119 recognizes that its own address is not coincident with the destination address in the request data frame, and discards the request data frame as a result of this recognition.

The request data frame which the electro-optical transducer module 121 in the second RIO unit 107 attempts to transmit, cannot reach the first RIO unit 106 since the optical cable T2 is cut off. Accordingly, such an operation as performed in the step S611 in FIG. 6 does not take place (S711). After this, such an operation as performed in the step S612 in FIG. 6 (S712) will not take place, either, through the line of 1st path. As a result, the request data frame does not reach the electro-optical transducer module 113 in the active CPU unit 103. Consequently, the frame discriminator 207 does not change the logical content of the request frame circulation flag register 209 to “true” (the flag remains lowered) within the predetermined length of time measured by the timer 211.

As described above, although the request data frame transmitted from the active CPU unit 103 is relayed through the line of 2nd path to the second RIO unit 107 by way of the third RIO unit 108, it cannot reach the first RIO unit 106 since the optical cable T2 between the second and first RIO units 107 and 106 is cut off. The CPU module 109 detects this abnormality occurring on the optical cable by recognizing that the flag of the request frame circulation flag register 205 is not raised within the predetermined length of time.

On the other hand, after the step S711, the reflective electro-optical transducer module 128 in the third RIO unit 108 sends the request data frame received from the electro-optical transducer module 113 in the active CPU unit 103, also to the electro-optical transducer module 134 in the standby CPU unit 129 through the optical cable V4 (S713). With this operation, the standby CPU unit 129 can perform the snooping of the request data frame on the line of 2nd path. In fact, the line failure assumed in FIG. 7 does not affect the snooping operation itself.

In the line failure described above, although the request data frame was able to be sent to the first RIO unit as the destination through the line of 1st path, the request data frame was not able to be sent to the first RIO unit 106 through the line of 2nd path. By providing duplicate ring-shaped networks and sending the data frames in the opposite directions through the respective networks, the plant control system 101 as an embodiment of this invention can continue to operate without any adverse effect on the control functions even when line failures occur. Further, the result of the line failure can be reflected to the request frame circulation flag register 205.

### [Reception of Reply Date Frame]

The RIO module 114 in the first RIO unit 106 which has received the request data frame in the previous step S703, reads the received request data frame in the step S703, and executes control operation. Then, upon receiving the result of execution, the RIO module 114 generates a reply data frame by using the result, and delivers the generated reply data frame onto the line of 1st and 2nd paths, simultaneously (S714).

The reply data frame transmitted by the RIO module 114 in the first RIO unit 106 reaches the electro-optical transducer module 117 and the reflective electro-optical transducer module 115 through the line of 1st path.

The reply data frame which the electro-optical transducer module 117 in the first RIO unit 106 attempts to relay, does not reach the second RIO unit 107 since the optical cable S2 is cut off. Accordingly, such an operation as performed in the step S615 in FIG. 6 will not take place (S704). After this, such operations (S716, S712) as performed in the steps S616, S617 and S618 in FIG. 6 will not take place, either. As a result, the reply data frame does not reach the electro-optical transducer module 112 in the active CPU unit 103. Consequently, the frame discriminator 202 does not change the logical content of the reply frame reception flag register 206 to “true” (the flag remains lowered) within the predetermined length of time measured by the timer 211.

As described above, the reply data frame transmitted from the first RIO unit 106 cannot reach the active CPU unit 103 by way of the second and third RIO units 107 and 108 through the line of 1st path since the line failure is present between the first and second RIO units 106 and 107. The CPU module 109 detects this abnormality occurring on the optical cables by recognizing that the flag of the reply frame reception flag register 206 is not raised within the predetermined length of time.

On the other hand, after the step S714, the reflective electro-optical transducer module 115 in the first RIO unit 106 sends the reply data frame received from the RIO module 114 in the first RIO unit 106, also to the electro-optical transducer module 133 in the standby CPU unit 129 (S707). With this operation, the standby CPU unit 129 can perform the snooping of the reply data frame on the line of 1st path. In fact, the line failure assumed in FIG. 7 does not affect the snooping operation itself.

After the step S714, the reply data frame transmitted by the RIO module 114 in the first RIO unit 106 reaches the reflective electro-optical transducer module 116 and the electro-optical transducer module 118 through the line of 2nd path.

The reply data frame relayed by the reflective electro-optical transducer module 116 in the first RIO unit 106 reaches the electro-optical transducer module 113 in the active CPU unit 103 through the optical cable T1 (S720). Then, the frame discriminator 207 changes the logical content of the reply frame reception flag register 210 to “true” (the flag is raised), and transmits the reply data frame to the CPU module 109 (S721).

On the other hand, after the step S714, the reply data frame which the electro-optical transducer module 118 in the first RIO unit 106 attempts to relay, does not reach the RIO module 119 since the optical cable V2 is cut off As a result, such an operation as performed in the step S622 in FIG. 6 will not take place (S722). After this, since such operations (S723, S724) as performed in the steps S623 and S624 in FIG. 6 will not take place, either, the reply data frame cannot reach the electro-optical transducer module 134 in the standby CPU unit 129. Consequently, the standby CPU unit 129 cannot perform the snooping of the reply data frame on the line of 2nd path.

In the line failure described above, although the reply data frame was not able to be sent to the first RIO unit 106 as a destination through the line of 1st path, the reply data frame was able to be sent to the active CPU unit 103 through the line of 2nd path. Also, the snooping of the reply data frame on the line of 1st path by the standby CPU unit 129 was possible while the snooping of the reply data frame on the line of 2nd path by the standby CPU unit 129 was impossible. By providing duplicate ring-shaped networks and sending the data frames in the opposite directions through the respective networks, the plant control system 101 as an embodiment of this invention can continue to operate without any adverse effect on the control functions even when line failures occur. Further, the result of the line failure can be reflected to the reply frame reception flag register 206.

### <<Failure Detection>>

As described above, as the active CPU unit 103 executes a polling operation in accordance with the flow chart shown in FIG. 5, the result of the polling operation is reflected to the six registers shown in FIG. 2. When the command apparatus 132 receives the contents of the flag registers as shown in FIG. 4A from the active CPU unit 103 (or the standby CPU unit 129 if the active CPU unit 103 is in a failure) through the command communication channel 131, the command apparatus 132 stores the received contents in the RAM (not shown) in the form of the list shown in FIG. 4B, determines whether there is any line failure or not, and specifies or estimates the location of the line failure if there is any.

In what follows, described is a method of specifying or estimating the location of a line failure by checking the contents of the flag registers.

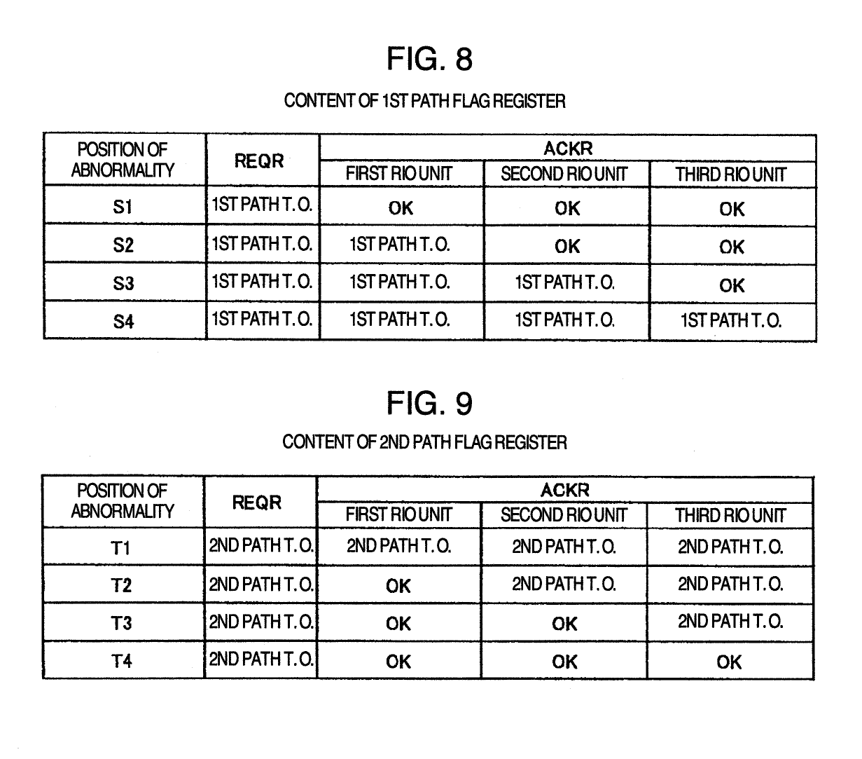

FIG. 8 shows the relationship between the contents of the flag registers belonging to the line of 1st path and the locations of line failures. Explanation will first be given to what becomes of the contents of the respective flag registers when any one of the optical cables S1, S2, S3 and S4 belonging to the line of 1st path is cut off.

If any one of those optical cables is cut off, the request frame circulation flag register 205 necessarily incurs time out so that the content of the request frame circulation flag register 205 remains to be logically “false”. For the brevity of notation in FIG. 8, this phenomenon is referred to as “1st path T. O.” which means “time out with respect to the line of 1st path”.

When the optical cable S1 connecting the active CPU unit 103 with the first RIO unit 106 is cut off, the line path proceeding via the first through third RIO units 106˜108 and returning to the active CPU unit 103 is free of failure so that the contents of the reply frame reception flag registers 206 become “OK”, that is, logical “true”.

If the optical cable S2 connecting the first RIO unit 106 with the second RIO unit 107 is cut off, the reply data frame transmitted from the first RIO unit 106 cannot reach the second RIO unit 107 due to the break of the optical cable S2. However, since the line path proceeding via the second and third RIO units 107 and 108 and reaching the active CPU unit 103 is free of failure, only the content of the reply frame reception flag register 206 in the first RIO unit 106 becomes “1st path T. O.”.

If the optical cable S3 connecting the second RIO unit 107 with the third RIO unit 108 is cut off, the reply data frames transmitted from the first and second RIO units 106 and 107 cannot reach the third RIO unit 108 due to the break of the optical cable S3. However, since the line path proceeding via the third RIO unit 108 and reaching the active CPU unit 103 remains free of failure, the contents of the reply frame reception flag registers 206 in either of the first and second RIO units 106 and 107 become “1st path T. O.”.

If the optical cable S4 connecting the third RIO unit 108 with the active CPU unit 103 is cut off, the reply data frames transmitted from the first, second and third RIO units 106, 107 and 108 cannot reach the active CPU unit 103 due to the break of the optical cable S4. Therefore, the contents of the reply frame reception flag registers 206 in all the first, second and third RIO units 106, 107 and 108 become “1st path T. O.”.

FIG. 9 shows the relationship between the contents of the flag registers belonging to the lines of subsystem 2 and the locations of line failures. Explanation will be given to what becomes of the contents of the respective flag registers when any one of the optical cables T1, T2, T3 and T4 belonging to the line of 2nd path is cut off.

If any one of those optical cables is cut off, the request frame circulation flag register 209 necessarily incurs time out so that the content of the request frame circulation flag register 209 remains to be logically “false”. For the brevity of notation in FIG. 9, this phenomenon is referred to as “2nd path T. O.” which means “time out with respect to the line of 2nd path”.

When the optical cable T1 connecting the active CPU unit 103 with the first RIO unit 106 is cut off; the reply data frame transmitted from the third, second and first RIO units 108, 107 and 106 cannot reach the active CPU unit 103 due to the break of the optical cable T1. Therefore, the contents of the reply frame reception flag registers 206 in all the first, second and third RIO units 106, 107 and 108 become “2nd path T. O.”

If the optical cable T2 connecting the first RIO unit 106 with the second RIO unit 107 is cut off, the reply data frame transmitted from the third and second RIO units 108 and 107 cannot reach the first RIO unit 106 due to the break of the optical cable T2. However, since the line path proceeding via the first RIO units 106 and reaching the active CPU unit 103 is free of failure, the contents of the reply frame reception flag registers 206 in either of the second and third RIO units 107 and 108 become “2nd path T. O.”.

If the optical cable T3 connecting the second RIO unit 107 with the third RIO unit 108 is cut off, the reply data frames transmitted from the third RIO units 108 cannot reach the second RIO unit 107 due to the break of the optical cable T3. However, since the line path proceeding via the second and first RIO units 107 and 106, and reaching the active CPU unit 103 remains free of failure, only the content of the reply frame reception flag register 206 in the third RIO unit 108 becomes “2nd path T. O.”.

If the optical cable T4 connecting the third RIO unit 108 with the active CPU unit 103 is cut off, the line path proceeding via the third through first RIO units 108˜106 and reaching the active CPU unit 103 is free of failure so that the contents of the reply frame reception flag registers 206 in all the RIO units become “OK”, that is, “logical true”.

Now, in consideration of the relationships shown in FIGS. 8 and 9, a procedure for determining or estimating the positions of line failure will be described under the assumption that two optical cables are cut off.

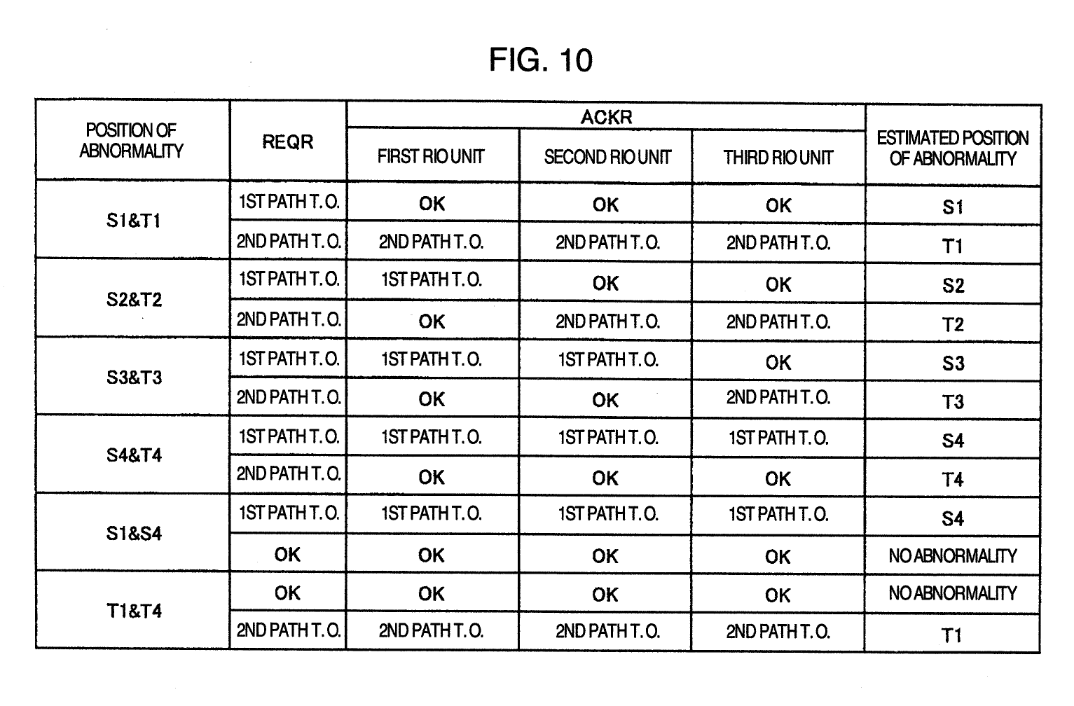

FIG. 10 shows the relationship between the contents of the flag registers belonging to the lines of 1st and 2nd paths and the positions of line failures.

If optical cables between the electro-optical transducer module 112 in the active CPU unit 103 and the reflective electro-optical transducer module 115 in the first RIO unit 106 are cut off, it is the optical cables S1 and T1 that are cut off. Accordingly, an estimation with a very high accuracy can be made that line failures exist on the optical cables S1 and T1, judged from the relationships shown in FIGS. 8 and 9.

If optical cables between the electro-optical transducer module in the first RIO units 106 and the electro-optical transducer module 123 in the second RIO unit 107 are cut off, it is the optical cables S2 and T2 that are cut off. Accordingly, an estimation with a very high accuracy can be made that line failures exist on the optical cables S2 and T2, judged from the relationships shown in FIGS. 8 and 9.

If optical cables between the electro-optical transducer module 123 in the second RIO unit 107 and the electro-optical transducer module in third RIO units 108 are cut off, it is the optical cables S3 and T3 that are cut off. Accordingly, an estimation with a very high accuracy can be made that line failures exist on the optical cables S3 and T3, judged from the relationships shown in FIGS. 8 and 9.

If optical cables between the electro-optical transducer module in the third RIO unit 108 and the electro-optical transducer module 112 in the active CPU unit 103, it is the optical cables S4 and T4 that are cut off. Accordingly, an estimation with a very high accuracy can be made that line failures exist on the optical cables S4 and T4, judged from the relationships shown in FIGS. 8 and 9.

If optical cables of 1st path connecting the active CPU unit 103 with the first and third RIO units 106 and 108 are cut off, it is the optical cables S1 and S4 that are cut off. In this case, the line of 1st path is completely separated from the active CPU unit 103 so that the contents of all the reply frame reception flag registers become “1st path T. O.”. Accordingly, although the outcome is the same as that corresponding to the case where the optical cable S4 is cut off as shown in FIG. 8, the contents of all the reply frame reception flag registers belonging to the line of 2nd path become “OK” since no line failure exists on the line of 2nd path. In this case, if the optical cable S4, which was estimated as broken, is repaired to restore its function, only the optical cable S1 remains in the abnormal condition and therefore there arises a necessity that the optical cable S1 should also be repaired to restore its function.

In like manner, if optical cables of 2nd path connecting the active CPU unit 103 with the first and third RIO units 106 and 108 are cut off, it is the optical cables T1 and T4 that are cut off. In this case, the line of 2nd path is completely separated from the active CPU unit 103 so that the contents of all the flag registers become “2nd path T. O.”. Accordingly, although the outcome is the same as that corresponding to the case where the optical cable T1 is cut off as shown in FIG. 9, the contents of all the reply frame reception flag registers belonging to the line of 1st path become “OK” since no line failure exists on the line of 1st path. In this case, if the optical cable T1, which was estimated as broken, is repaired to restore its function, only the optical cable T4 remains in the abnormal condition and therefore there arises a necessity that the optical cable T4 should also be repaired to restore its function.

Further, a procedure for determining or estimating the position of abnormality will be described under the assumption that one or more RIO unit, instead of optical cables, breaks down due to, for example, power failure.

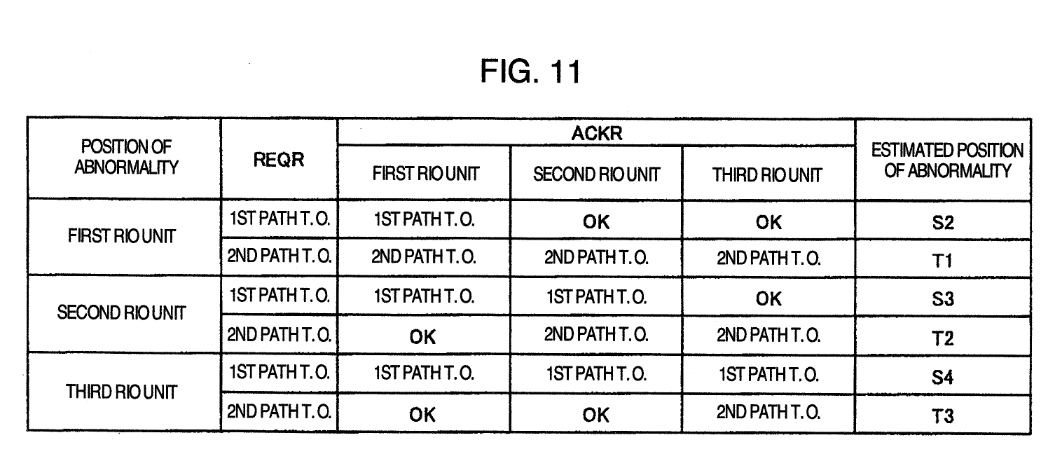

FIG. 11 shows the relationship between the contents of the flag registers belonging to the lines of 1st and 2nd paths and the positions of abnormalities.

If the first RIO unit 106 loses its function due to, for example, power failure, the active CPU unit 103 cannot communicate at all with the first RIO unit 106 through the lines of 1st and 2nd paths. Accordingly, the contents of the reply frame reception flag registers 206 and 210 of the 1st and 2nd paths become “1st path T. O.” and “2nd path T. O.”, respectively in the first RIO unit 106. On the other hand, although the reply data frames transmitted from the second and third RIO units 107 and 108 cannot reach the active CPU unit 103 through the line of 2nd path, it can reach the active CPU 103 through the line of 1st path. Consequently, the content of the reply frame reception flag register 206 of the 1st path becomes “1st path OK” while the content of the reply frame reception flag register 210 of the 2nd path becomes “2nd path T. O.” in the second and third RIO units 107 and 108.

In the case described just above, the estimated positions of failures will be on the optical cables “S2” and “T1” according to FIGS. 8 and 9. However, since the probability that a line failure occurs in which the optical cables “S2” and “T1” are cut off simultaneously, is low, the failure of the first RIO unit 106 which is interposed between the optical cables “S2” and “T1” is suspected.

If the second RIO unit 107 loses its function due to, for example, power failure, the active CPU unit 103 cannot communicate at all with the second RIO unit 107 through the lines of 1st and 2nd paths. Accordingly, the contents of the reply frame reception flag registers 206 and 210 of the 1st and 2nd paths become “1st path T. O.” and “2nd path T. O.”, respectively in the second RIO unit 107. On the other hand, although the reply data frame transmitted from third RIO unit 108 cannot reach the active CPU unit 103 through the line of 2nd path, it can reach the active CPU 103 through the line of 1st path. In like manner, although the reply data frame transmitted from the first RIO unit 106 cannot reach the active CPU unit 103 through the line of 1st path, it can reach the active CPU unit 1034 through the line of 2nd path. Consequently, the content of the reply frame reception flag register 206 of the line of 1st path becomes “1st path T. O.” while the content of the reply frame reception flag register 210 of the line of 2nd path becomes “OK” in the first RIO unit 106. And the content of the reply frame reception flag register 206 of the line of 1st path becomes “OK” while the content of the reply frame reception flag registers 210 of the line of 2nd path becomes “2nd path T. O.” in the third RIO unit 108.

In the case described just above, the estimated positions of failures will be on the optical cables “S3” and “T2” according to FIGS. 8 and 9. However, since the probability that a line failure occurs in which the optical cables “S2” and “T1” are cut off simultaneously, is low, the failure of the second RIO unit 107 which is interposed between the optical cables “S3” and “T2” is suspected.

If the third RIO unit 108 loses its function due to, for example, power failure, the active CPU unit 103 cannot communicate at all with the third RIO unit 108 through the lines of 1st and 2nd paths. Accordingly, the contents of the reply frame reception flag registers 206 and 210 of the 1st and 2nd paths become “1st path T. O.” and “2nd path T. O.”, respectively in the third RIO unit 108. On the other hand, although the reply data frames transmitted from the first and second RIO units 106 and 107 cannot reach the active CPU unit 103 through the line of 1st path, it can reach the active CPU 103 through the line of 2nd path. Consequently, the content of the reply frame reception flag register 206 of the line of 1st path becomes “1st path T. O.” while the content of the reply frame reception flag register 210 of the line of 2nd path becomes “2nd path OK” in the first and second RIO units 106 and 107.

In the case described just above, the estimated positions of failures will be on the optical cables “S4” and “T3” according to FIGS. 8 and 9. However, since the probability that a line failure occurs in which the optical cables “S4” and “T3” are cut off simultaneously, is low, the failure of the third RIO unit 108 which is interposed between the optical cables “S4” and “T3” is suspected.

The command apparatus 132 contains the tables shown in FIGS. 8, 9, 10 and 11, and notifies the user of the presence or absence of failures and the estimated locations of the failures.

The embodiment of this invention described up to here can be variously modified without departing from the scope of this invention, which is apparent to those skilled in the art.

For example, the three pairs of flag registers may be replaced by so many counters.

The request frame transmission flag register 204 serves to check the soundness of the control line EL110. The request frame circulation flag register 205 serves to check the soundness of the entire line of 1st path. The reply frame reception flag register 206 serves to check the soundness of part of the line of 1st path.

In consideration of the functions of these flag registers, counters may replace the flag registers in such a manner that the value “0” in the counters indicates a failure in the control line EL110; “1” a failure in the entire line of 1st path; “2” a partial failure in the line of 1st path; and “3” the soundness of the line of 1st path.

The embodiment of this invention was described as applied to a plant control system in the foregoing.

In the plant control system described above, the loops of the lines of 1st and 2nd paths through which data frames travel in the opposite directions are provided, connecting the active CPU unit and the three RIO units. Further, the RIO units which are connected with the active CPU unit are provided with the reflective electro-optical transducer modules, so that they can also be connected with the standby CPU unit. The loops of the lines of 1st and 2nd paths connecting the active CPU unit and the RIO units are opposite in signal transfer direction to the loops of the lines of 1st and 2nd paths connecting the standby CPU unit and the RIO units. With this network described above, the plant control system according to this invention can exhibit a high resistivity to such line failures as might occur in a concentrated manner and therefore provide a high availability. Further, by installing the flag registers and the timer in the active CPU, which check whether or not data frames have reached their destinations within a determined length of time, failure locations can be securely determined or estimated.

It should be further understood by those skilled in the art that although the foregoing description has been made on embodiments of the invention, the invention is not limited thereto and various changes and modifications may be made without departing from the spirit of the invention and the scope of the appended claims.

1. A control system comprises:
a first CPU module for simultaneously transmitting request data frames onto lines of 1st and 2nd paths and for receiving reply data frames from the lines of 1st and 2nd paths;
a first transducer module connected with the line of 1st path of the first CPU module, for outputting the request data frame at its transmission terminal and for receiving the reply data frame at its reception terminal;
a second transducer module connected with the line of 2nd path of the first CPU module, for outputting the request data frame at its transmission terminal and for receiving the reply data frame at its reception terminal;
a first remote input/output module connected with an actuator and a sensor installed on a controlled system, for receiving the request data frames from the lines of 1st and 2nd paths and for simultaneously transmitting the reply data frames onto the lines of 1st and 2nd paths;
a third transducer module connected with the line of 1st path of the first remote input/output module, for receiving the request data frame from the transmission terminal of the first transducer module;
a fourth transducer module connected with the line of 1st path of the first remote input/output module, for outputting the reply data frame at its transmission terminal;
a fifth transducer module connected with the line of 2nd path of the first remote input/output module, for outputting the reply data frame to the reception terminal of the second transducer module;
a sixth transducer module connected with the line of 2nd path of the first remote input/output module, for receiving the request data frame;
a second remote input/output module having the same configuration as the first remote input/output module, for receiving the request data frames from the lines of 1st and 2nd paths and for simultaneously transmitting the reply data frames onto the lines of 1st and 2nd paths;
a seventh transducer module connected with the line of 1st path of the second remote input/output module, for receiving the request data frame from the transmission terminal of the fourth transducer module;
an eighth transducer module connected with the line of 1st path of the second remote input/output module, for outputting reply data frame at its transmission terminal;
a ninth transducer module connected with the line of 2nd path of the second remote input/output module, for outputting the reply data frame to the reception terminal of the sixth transducer module; and
a tenth transducer module connected with the line of 2nd path of the second remote input/output module, for receiving the request data frame from the reception terminal of the second transducer module.

2. A control system as claimed in claim 1, further comprising:
a second CPU module having the same configuration as the first CPU module, for simultaneously transmitting request data frames onto lines of 1st and 2nd paths and for receiving reply data frames from the lines of 1st and 2nd paths;
an eleventh transducer module connected with the line of 1st path of the second CPU module, for transmitting the request data frame via its transmission terminal to the ninth transducer module and for receiving the reply data frame via its reception terminal from the third transducer module; and
a twelfth transducer module connected with the line of 2nd path of the second CPU module, for transmitting the request data frame via its transmission terminal to the fourth transducer module and for receiving the reply data frame via its reception terminal from the tenth transducer module.

3. A control system as claimed in claim 2, wherein
the third transducer module transmits the request data frame to the eleventh transducer module when the third transducer module receives the request data frame from the first transducer module;
the fourth transducer module transmits the request data frame to the second transducer module when the fourth transducer module receives the request data frame from the twelfth transducer module;
the ninth transducer module transmits the request data frame to the first transducer module when the ninth transducer module receives the request data frame from the eleventh transducer module; and
the tenth transducer module transmits the request data frame to the twelfth transducer module when the tenth transducer module receives the request data frame from the second transducer module.

4. A CPU unit comprising:
a CPU module for simultaneously transmitting request data frames onto lines of 1st and 2nd paths and for receiving reply data frames from the lines of 1st and 2nd paths;
a first transducer module connected with the line of 1st path of the CPU module, for outputting the request data frame at its transmission terminal and for receiving the reply data frame at its reception terminal;
a second transducer module connected with the line of 2nd path of the CPU module, for outputting the request data frame at its transmission terminal and for receiving the reply data frame at its reception terminal;
a first frame discriminator for discriminating the sorts of the request and reply data frames arriving at the first transducer module;
a first request frame transmission flag register in which the fact that a request data frame has been transmitted from the CPU module, is recorded by the first frame discriminator when the first frame discriminator detects the transmission of the request data frame from the CPU module;
a first request frame circulation flag register in which the fact that a reply data frame has arrived from outside, is recorded by the first frame discriminator when the first frame discriminator detects the arrival of the reply data frame from outside while the first request frame transmission flag register retains the record that the CPU module has transmitted a request data frame;
a first reply frame reception flag register in which the fact that a reply data frame has arrived from outside, is recorded by the first frame discriminator when the first frame discriminator detects the arrival of the reply data frame from outside while the first request frame circulation flag register retains the record that the request data frame has arrived from outside;
a second frame discriminator for discriminating the sorts of the request and reply data frames arriving at the second transducer module;
a second request frame transmission flag register in which the fact that a request data frame has been transmitted from the CPU module, is recorded by the second frame discriminator when the second frame discriminator detects the transmission of the request data frame from the CPU module;
a second request frame circulation flag register in which the fact that a reply data frame has arrived from outside, is recorded by the second frame discriminator when the second frame discriminator detects the arrival of the reply data frame from outside while the second request frame transmission flag register retains the record that the CPU module has transmitted a request data frame;
a second reply frame reception flag register in which the fact that a reply data frame has arrived from outside, is recorded by the second frame discriminator when the second frame discriminator detects the arrival of the reply data frame from outside while the second request frame circulation flag register retains the record that the reply data frame has arrived from outside; and
a timer for measuring the time interval between the instant that the CPU module transmits a request data frame and the instant that the CPU module receives a reply data frame.
